(19) United States
(12) Patent Application Publication
(10) Pub. No.: US 2024/0043600 A1
(43) Pub. Date: Feb. 8, 2024

(54) ETHYLENE-RICH DIENE TRIBLOCK POLYMER HAVING A STATISTICAL BLOCK AND TWO TERMINAL POLYETHYLENE BLOCKS

(71) Applicants: COMPAGNIE GENERALE DES ETABLISSEMENTS MICHELIN, Clermont-Ferrand (FR); CENTRE NATIONAL DE LA RECHERCHE SCIENTIFIQUE, Paris Cedex 16 (FR); ECOLE SUPÉRIEURE DE CHIMIE PHYSIQUE ELECTRONIQUE DE LYON, Villeurbanne Cedex (FR); UNIVERSITÉ CLAUDE BERNARD LYON 1, Villeurbanne Cedex (FR)

(72) Inventors: Nicolas BAULU, Clermont-Ferrand Cedex 9 (FR); Christophe BOISSON, Tramoyes (FR); Franck D'AGOSTO, Genas (FR); Damien MONTARNAL, Ruy Montceau (FR); Emma MORESO, Clermont-Ferrand Cedex 9 (FR); Julien THUILLIEZ, Clermont-Ferrand Cedex 9 (FR); François JEAN-BAPTISTE-DIT-DOMINIQUE, Clermont-Ferrand Cedex 9 (FR)

(21) Appl. No.: 18/038,747

(22) PCT Filed: Nov. 22, 2021
(86) PCT No.: PCT/FR2021/052058

§ 371 Date: May 25, 2023

(30) Foreign Application Priority Data
Nov. 26, 2020 (FR) FR2012206

(51) Int. Cl. C08F 297/08

(52) U.S. Cl. CPC C08F 297/086; C08F 2410/01; C08F 2420/04; C08F 2800/10

(57) ABSTRACT

A triblock polymer of formula B-A-B is provided. According to the formula, the symbol A represents a “central” block which is a statistical copolymer comprising units of a 1,3-diene and more than 50 mol % of ethylene units. The symbols B each represent an “end” block which is a polyethylene with a melting point of greater than 90° C. and a number-average molar mass of greater than or equal to 2000 g/mol and less than or equal to 10 000 g/mol. The polymer has improved rheological properties relative to a statistical copolymer based on ethylene and 1,3-diene of the same microstructure without changing its mechanical and dynamic or thermal properties.

This U.S. patent application is a national phase entry of international patent application no. PCT/FR2021/052058, filed Nov. 22, 2021, which claims priority to French patent application no. FR2012206, filed Nov. 26, 2020, the entire contents of which are incorporated herein by reference in their entirety.

### BACKGROUND

### 1. Technical Field

The field of the present invention is that of diene copolymers that are rich in ethylene units.

### 2. Related Art

It has been shown that statistical copolymers based on ethylene and 1,3-diene and that are rich in ethylene units have advantageous stiffness, hysteresis, wear and adhesion properties. Reference may be made, for example, to patent applications WO 2014/114607 A1, WO 2016/012259 A1 and WO 2016/087248 A1.

Another advantage of these copolymers is the use of ethylene which is a common and commercially available monomer, which is accessible via the fossil or biological route. Another advantage of these copolymers is the presence of ethylene units along the polymer backbone, which units are much less sensitive than diene units to oxidizing or thermal-oxidizing degradation mechanisms, which gives the materials better stability and lifetime.

Controlling the rheology of a polymer is a key parameter in the industrialization and use of a polymer. The manufacture of articles entirely or partly made of a polymer generally requires various operations such as kneading, extrusion, moulding, etc., during which operations the polymer is subjected to a wide range of frequency stresses. The rheology of the polymer must be suitable for these various operations in order to meet the quality criteria of the article to be manufactured and the productivity criteria in the production line of the article. In particular, a high viscosity at low frequency strains is desirable in order to limit the flow phenomena of the polymer. Solutions for increasing the viscosity at low shear rates without affecting the viscosity at higher shear rates are described, for example, in WO 99/10421 A1. They consist in crosslinking the polymer by radical reaction or in modifying it with a polyfunctional coupling agent that can be inserted into C—H bonds. The grafting of an associative function on a polymer is also a solution described in patent application WO 2008/099125 A1 for improving the rheological properties of a polymer.

### SUMMARY

The Applicants have discovered that it is possible to improve the rheological properties of statistical copolymers based on ethylene and on 1,3-diene and that are rich in ethylene units without modifying the mechanical and dynamic or thermal properties thereof.

Thus, a first subject of the invention is a triblock polymer of formula B-A-B in which the symbol A represents a “central” block which is a statistical copolymer comprising units of a 1,3-diene and more than 50 mol % of ethylene units, and the symbols B each represent an “end” block which is a polyethylene with a melting point of greater than 90° C. and a number-average molar mass of greater than or equal to 2000 g/mol and less than or equal to 10 000 g/mol, the content of the ethylene units in the central block being expressed as a molar percentage relative to the number of moles of monomer units constituting the central block.

A second subject of the invention is a composition which comprises a triblock polymer in accordance with the invention and another component.

A third subject of the invention is a process for synthesizing a triblock polymer in accordance with the invention.

### DETAILED DESCRIPTION OF EXAMPLE EMBODIMENTS

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

The expression “based on” used to define the constituents of a catalytic system or of a composition is understood to mean the mixture of these constituents, or the product of the reaction of a portion or of all of these constituents with one another.

Unless otherwise indicated, the contents of the units resulting from the insertion of a monomer into a polymer are expressed as a molar percentage relative to the total monomer units that constitute the polymer.

The compounds mentioned in the description may be of fossil origin or may be biobased. In the latter case, they can result, partially or completely, from biomass, or be obtained from renewable raw materials resulting from biomass. Similarly, the compounds mentioned may also be derived from the recycling of already-used materials, i.e. they may be partly or totally derived from a recycling process, or obtained from raw materials which are themselves derived from a recycling process.

The polymer in accordance with the invention is a triblock of formula B-A-B. A, referred to as the central block, represents a block which is a statistical copolymer containing ethylene units and units of a 1,3-diene, which means that the constituent monomer units of the central block are statistically distributed in the central block, due to a statistical incorporation of the monomers into the growing polymer chain. The other two blocks represented by B are each a homopolymer, a polyethylene.

In a known manner, the term “ethylene unit” means a unit bearing the —(CH₂—CH₂)—moiety. The ethylene units present in block A referred to as the central block represent more than 50 mol % of the units which constitute the central block. In the present patent application, the content of ethylene units in the central block, i.e. the number of moles of ethylene units in the central block, is expressed as a molar percentage relative to the number of moles of monomer units constituting the central block.

According to any one of the embodiments of the invention, the central block is preferably a statistical copolymer of ethylene and of the 1,3-diene, in which case the monomer units of the central block are those resulting from the copolymerization of ethylene and the 1,3-diene and are distributed statistically in the central block.

According to the invention, the 1,3-diene whose monomer units constitute the central block is a single compound, i.e. a single 1,3-diene, or is a mixture of 1,3-dienes which differ from each other in chemical structure. The 1,3-diene is preferably 1,3-butadiene, isoprene or a mixture of 1,3-dienes, one of which is 1,3-butadiene. The 1,3-diene is more preferentially 1,3-butadiene. Very preferentially, the central block is a statistical copolymer of ethylene and 1,3-butadiene.

In a known manner, a 1,3-diene may be inserted into a growing polymer chain by a 1,4 or 2,1 insertion or 3,4 insertion in the case of substituted diene such as isoprene to give rise to the formation of the 1,3-diene unit of 1,4 configuration, the 1,3-diene unit of 1,2 configuration or of 3,4 configuration, respectively. Preferably, the units of the 1,3-diene in the 1,2 configuration and the units of the 1,3-diene in the 3,4 configuration represent more than 50 mol % of the units of the 1,3-diene.

According to one embodiment of the invention, the central block contains units of the 1,3-diene of 1,4 configuration, preferably trans-1,4 configuration. Preferably, the units of the 1,3-diene of trans-1,4 configuration represent more than 50 mol % of the units of the 1,3-diene of 1,4 configuration. More preferentially, the units of the 1,3-diene of trans-1,4 configuration represent 100 mol % of the units of the 1,3-diene of 1,4 configuration.

According to a particularly preferred embodiment of the invention, the central block contains units of the 1,3-diene which contain more than 50 mol % of the units of 1,2 or 3,4 configuration, the balance to 100% of the units of the 1,3-diene being units of trans-1,4 configuration.

According to another particularly preferential embodiment of the invention, in particular when the 1,3-diene is 1,3-butadiene or a mixture of 1,3-dienes, one of which is 1,3-butadiene, the central block also contains 1,2-cyclohexanediyl units or 1,4-cyclohexanediyl units, preferably 1,2-cyclohexanediyl units. The presence of these cyclic structures in the central block results from a very particular insertion of the ethylene and 1,3-butadiene during their copolymerization. The mechanism for obtaining such a microstructure is described, for example, in Macromolecules 2009, 42, 3774-3779. The content of 1,2-cyclohexanediyl units and of 1,4-cyclohexanediyl units in the central block varies according to the respective contents of ethylene and 1,3-butadiene in the central block. The central block generally contains less than 10 mol % of 1,2-cyclohexanediyl units and 1,4-cyclohexanediyl units for the highest contents of ethylene in the central block and may contain more than 10% thereof for the lowest contents of ethylene in the central block, for example up to 15%, this percentage being relative to the number of moles of monomer units making up the central block. The 1,2-cyclohexanediyl unit corresponds to the following formula.

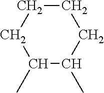

As the stiffness of the triblock polymer increases with the content of ethylene units in the central block, a triblock polymer with a particularly high content of ethylene units in the central block may be desired for applications where high stiffness of the material is required. Preferably, the ethylene units in the central block represent more than 60 mol % of the units which constitute the central block, in which case the central block contains more than 60 mol % of ethylene units. More preferentially, the ethylene units in the central block represent at least 70 mol % of the units which constitute the central block, in which case the central block contains at least 70 mol % of ethylene units.

According to one particular embodiment of the invention, the ethylene units in the central block represent not more than 90 mol % of the units which constitute the central block, in which case the central block contains not more than 90 mol % of ethylene units.

According to another particular embodiment of the invention, the ethylene units in the central block represent not more than 85 mol % of the units which constitute the central block, in which case the central block contains not more than 85 mol % of ethylene units.

Preferably, the central block has a glass transition temperature of between −90° C. and −20° C. More preferentially, the glass transition temperature of the central block is between −60° C. and −20° C., advantageously between −50° C. and −30° C.

The central block preferably has a number-average molar mass of greater than or equal to 3000 g/mol and less than or equal to 80 000 g/mol.

The “end” blocks B have the essential feature of each being a polyethylene having a number-average molar mass of greater than or equal to 2000 g/mol and less than or equal to 10 000 g/mol. The end blocks also have another essential feature of having a melting point above preferably above 90° C. and below 140° C. Preferably, B represents a linear polyethylene.

The triblock in accordance with the invention may be prepared according to a process which comprises the statistical copolymerization of a monomer mixture containing ethylene and the 1,3-diene, followed by the subsequent polymerization of ethylene.

The catalytic system used in the process for synthesizing the block polymer is advantageously a catalytic system based at least on a metallocene of formula (I) and an organomagnesium reagent

P(Cp¹Cp²)Nd(BH₄)_{1+y})Li_{y}(THF)ₓ (I)

Cp¹ and Cp², which are identical or different, being chosen from the group consisting of cyclopentadienyl groups and fluorenyl groups, the groups being substituted or unsubstituted,

P being a group bridging the two Cp¹ and Cp² groups and representing a ZR¹R² group, Z representing a silicon or carbon atom, R¹ and R², which are identical or different, each representing an alkyl group comprising from 1 to 20 carbon atoms, preferably a methyl,

y, which is an integer, being equal to or greater than 0,

x, which is or is not an integer, being equal to or greater than 0.

In formula (I), the neodymium atom is connected to a ligand molecule consisting of the two

Cp¹ and Cp² groups which are connected together by the bridge P. Preferably, the symbol P, denoted by the term bridge, corresponds to the formula ZR¹R², Z representing a silicon atom, R¹ and R², which are identical or different, representing an alkyl group comprising from 1 to 20 carbon atoms. More preferentially, the bridge P is of formula SiR¹R², R¹ and R² being identical and as defined above. More preferentially still, P corresponds to the formula SiMe_{2.}

As substituted cyclopentadienyl and fluorenyl groups, mention may be made of those substituted with alkyl radicals containing from 1 to 6 carbon atoms or with aryl radicals containing from 6 to 12 carbon atoms or else with trialkylsilyl radicals, such as SiMe₃. The choice of the radicals is also guided by the accessibility to the corresponding molecules, which are the substituted cyclopentadienes and fluorenes, because the latter are commercially available or can be easily synthesized.

As substituted cyclopentadienyl groups, mention may be made of those substituted in the 2 (or 5) position and also in the 3 (or 4) position, particularly those substituted in the 2 position, more particularly the tetramethylcyclopentadienyl group. In the present application, in the case of the cyclopentadienyl group, the 2 (or 5) position denotes the position of the carbon atom which is adjacent to the carbon atom to which the bridge P is attached, as is represented in the diagram below.

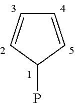

As substituted fluorenyl groups, mention may be made of those substituted in position 2, 7, 3 or 6, particularly 2,7-di(tert-butyl)fluorenyl and 3,6-di(tert-butyl)fluorenyl groups. The 2, 3, 6 and 7 positions respectively denote the position of the carbon atoms of the rings as represented in the diagram below, the 9 position corresponding to the carbon atom to which the bridge P is attached.

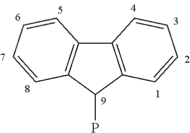

Preferably, Cp¹ and Cp² are identical and are chosen from the group consisting of substituted fluorenyl groups and the fluorenyl group. Advantageously, in formula (I) Cp¹ and Cp² each represent a substituted fluorenyl group or a fluorenyl group, preferably a fluorenyl group. The fluorenyl group is of formula C₁₃H₈. Preferably, the metallocene is of formula (Ia), (Ib), (Ic), (Id) or (Ie), in which the symbol Flu presents the fluorenyl group of formula C₁₃H_{8.}

[{Me₂SiFlu₂Nd(μ-BH₄)₂Li(THF)}_{2]} (Ia)

[Me₂SiFlu₂Nd(μ-BH₄)₂Li(THF)] (Ib)

[Me₂SiFlu₂Nd(μ-BH₄)(THF)] (Ic)

[{Me₂SiFlu₂Nd(μ-BH₄)(THF)}₂] (Id)

[Me₂SiFlu₂Nd(μ-BH₄)] (Ie)

The organomagnesium reagent used in the catalytic system as a co-catalyst is an organomagnesium compound of formula (II) or of formula (III),

R^{B}—(Mg—R^{A})ₘ—Mg—R^{B} (II)

X—Mg—R^{C}—Mg—X (III)

R^{A} being a divalent aliphatic hydrocarbon-based chain, interrupted or not with one or more oxygen or sulfur atoms or with one or more arylene groups,

R^{B} comprising a benzene nucleus substituted with the magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl,

R^{C} being a divalent aliphatic hydrocarbon-based chain, interrupted or not with one or more oxygen or sulfur atoms or with one or more arylene groups,

X being a halogen atom,

m being a number greater than or equal to 1 and preferably equal to 1.

The co-catalysts of formulae (II) and (III) both have the particular feature of including magnesium-carbon bonds involving different magnesium atoms. In formula (II), two magnesium atoms each share a first bond with a first carbon atom belonging to R^{B} and a second bond with a second carbon atom belonging to R^{A}. The first carbon atom is a constituent of the benzene nucleus of R^{B}. The second carbon atom is a constituent of the aliphatic hydrocarbon-based chain R^{A} which may contain within its chain one or more heteroatoms chosen from oxygen and sulfur or one or more arylene groups. In the preferential case where m is equal to 1, each magnesium atom thus shares a first bond with a first carbon atom of R^{B} and a second bond with a second carbon atom of R^{A}. In formula (III), each magnesium atom thus shares a first bond with a halogen atom and a second bond with a carbon atom of R^{C.}

In formula (II), R^{B} has the characteristic feature of comprising a benzene nucleus substituted with the magnesium atom. The two carbon atoms of the benzene nucleus of R^{B} ortho to the magnesium bear an identical or different substituent. Alternatively, one of the two carbon atoms of the benzene nucleus of R^{B} ortho to the magnesium may bear a substituent, and the other carbon atom of the benzene nucleus of R^{B} ortho to the magnesium may form a ring. The substituent is a methyl, an ethyl or an isopropyl. In the case where one of the two carbon atoms of the benzene nucleus of R^{B} ortho to the magnesium is substituted with an isopropyl, the second carbon atom of the benzene nucleus of R^{B} ortho to the magnesium is preferably not substituted with an isopropyl. Preferably, the carbon atoms of the benzene nucleus of R^{B} ortho to the magnesium are substituted with a methyl or an ethyl. More preferentially, the carbon atoms of the benzene nucleus of R^{B} ortho to the magnesium are substituted with a methyl.

The organomagnesium compound of formula (II) preferentially corresponds to formula (IIa-m) in which m is greater than or equal to 1, R₁ and R₅, which are identical or different, represent a methyl or an ethyl, preferably a methyl, R₂, R₃ and R₄, which are identical or different, represent a hydrogen atom or an alkyl and R^{A} is a divalent aliphatic hydrocarbon-based chain, interrupted or not with one or more oxygen or sulfur atoms or with one or more arylene groups. Preferably, R₁ and R₅ represent a methyl. Preferably, R₂ and R₄ represent a hydrogen atom.

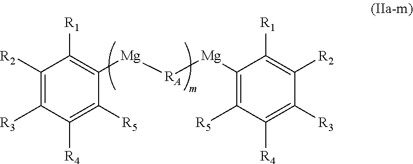

The organomagnesium compound of formula (IIa-m) is of formula (IIa-1) in the case where m is equal to 1.

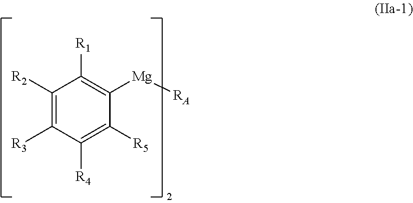

According to a preferential variant, R₁, R₃ and R₅ are identical in formula (IIa-m), notably in formula (IIa-1). According to a more preferential variant, R₂ and R₄ represent a hydrogen and R₁, R₃ and R₅ are identical. In a more preferential variant, R₂ and R₄ represent a hydrogen and R₁, R₃ and R₅ represent a methyl.

In formulae (II) and (IIa-m), in particular in formula (IIa-1), R^{A} is a divalent aliphatic hydrocarbon-based chain which may contain within its chain one or more heteroatoms chosen from oxygen and sulfur or one or more arylene groups. Preferably, R^{A} is a branched or linear alkanediyl, cycloalkanediyl or xylenediyl radical. More preferentially, R^{A} is an alkanediyl.

Preferably, R^{A} contains 3 to 10 carbon atoms, in particular 3 to 8 carbon atoms.

Even more preferentially, R^{A} is an alkanediyl containing 3 to 10 carbon atoms. Advantageously, R^{A} is an alkanediyl containing 3 to 8 carbon atoms. Very advantageously, R^{A} is a linear alkanediyl. 1,3-propanediyl, 1,4-butanediyl, 1,5-pentanediyl, 1,6-hexanediyl, 1,7-heptanediyl and 1,8-octanediyl are most particularly suitable as groups R^{A.}

According to any one of the embodiments of the invention, m is preferentially equal to 1 in formula (II), in particular in formula (IIa-m).

The organomagnesium compound of formula (II) may be prepared via a process which comprises the reaction of a first organomagnesium reagent of formula X′Mg—R^{A}—MgX' with a second organomagnesium reagent of formula R^{B}—Mg—X′, in which X′ represents a halogen atom, preferentially bromine or chlorine, R^{B} and R^{A} being as defined previously. X′ is more preferentially a bromine atom. The stoichiometry used in the reaction determines the value of m in formula (II) and in formula (IIa-m). For example, a mole ratio of 0.5 between the amount of the first organomagnesium reagent and the amount of the second organomagnesium reagent is favourable to the formation of an organomagnesium compound of formula (II) in which m is equal to 1, whereas a mole ratio of greater than 0.5 will be more favourable to the formation of an organomagnesium compound of formula (II) in which m is greater than 1.

To perform the reaction of the first organomagnesium reagent with the second organomagnesium reagent, a solution of the second organomagnesium reagent is typically added to a solution of the first organomagnesium reagent. The solutions of the first organomagnesium reagent and the second organomagnesium reagent are generally solutions in an ether, such as diethyl ether, dibutyl ether, tetrahydrofuran, methyltetrahydrofuran, or a mixture of two or more of these ethers. Preferably, the respective concentrations of the solutions of the first organomagnesium reagent and the second organomagnesium reagent are from 0.01 to 3 mol/L and from 0.02 to 5 mol/L, respectively. More preferentially, the respective concentrations of the first organomagnesium reagent and the second organomagnesium reagent are from 0.1 to 2 mol/L and from 0.2 to 4 mol/L, respectively.

The first organomagnesium reagent and the second organomagnesium reagent may be prepared beforehand by a Grignard reaction from magnesium metal and a suitable precursor. For the first organomagnesium reagent and the second organomagnesium reagent, the respective precursors are of formulae X′—R^{A}—X′ and R^{B}—X′, R^{A}, R^{B} and X′ being as defined previously. The Grignard reaction is typically performed by adding the precursor to magnesium metal which is generally in the form of chips. Preferably, iodine (I₂) typically in the form of beads is introduced into the reactor prior to the addition of the precursor to activate the Grignard reaction in a known manner.

Alternatively, the organomagnesium compound in accordance with the invention may be prepared by reacting an organometallic compound of formula M—R^{A}—M and the organomagnesium reagent of formula R^{B}—Mg-X′, where M represents a lithium, sodium or potassium atom, X′, R^{B} and R^{A} being as defined previously. Preferably, M represents a lithium atom, in which case the organometallic compound of formula M—R^{A}—M is an organolithium reagent.

The reaction of the organolithium reagent and of the organomagnesium reagent is typically performed in an ether such as diethyl ether, dibutyl ether, tetrahydrofuran or methyltetrahydrofuran. The reaction is also typically performed at a temperature ranging from 0° C. to 60° C. The placing in contact is preferably performed at a temperature of between 0° C. and 23° C. The placing in contact of the organometallic compound of formula M—R^{A}—M with the organomagnesium reagent of formula R^{B}—Mg—X′ is preferentially performed by adding a solution of the organometallic compound M—R^{A}—M to a solution of the organomagnesium reagent R^{B}—Mg—X′. The solution of the organometallic compound M—R^{A}—M is generally a solution in a hydrocarbon-based solvent, preferably n-hexane, cyclohexane or methylcyclohexane. The solution of the organomagnesium reagent R^{B}—Mg—X′ is generally a solution in an ether, preferably diethyl ether or dibutyl ether. Preferably, the respective concentrations of the solutions of the organometallic compound and of the organomagnesium reagent M—R^{A}—M and R^{B}—Mg—X′ are from 0.01 to 1 mol/L and from 0.02 to 5 mol/L, respectively. More preferentially, the respective concentrations of the solutions of the organometallic compound and of the organomagnesium reagent M—R^{A}—M and R^{B}—Mg—X′ are from 0.05 to 0.5 mol/L and from 0.2 to 3 mol/L, respectively.

As with any synthesis performed in the presence of organometallic compounds, the syntheses described for the synthesis of the organomagnesium reagents take place under anhydrous conditions under an inert atmosphere, in stirred reactors. Typically, the solvents and the solutions are used under anhydrous nitrogen or argon.

Once the organomagnesium compound of formula (II) has been formed, it is generally recovered in solution after filtration performed under an inert anhydrous atmosphere. It may be stored prior to use in its solution in sealed containers, for example capped bottles, at a temperature of between −25° C. and 23° C.

Like any organomagnesium compound, the organomagnesium compound of formula (II) may be in the form of a monomeric species (R^{B}—(Mg—R^{A})ₘ—Mg—R^{B})₁ or in the form of a polymeric species (R^{B}—(Mg—R^{A})ₘ—Mg—R^{B})ₚ, where p is an integer greater than 1, notably dimer (R^{B}—(Mg—R^{A})ₘ—Mg—R^{B})₂, where m is as defined previously. Moreover, whether it is in the form of a monomer or polymer species, it may also be in the form of a species coordinated to one or more molecules of a solvent, preferably of an ether such as diethyl ether, tetrahydrofuran or methyltetrahydrofuran.

In formula (III), R^{c} is a divalent aliphatic hydrocarbon-based chain which may contain within its chain one or more heteroatoms chosen from oxygen and sulfur or one or more arylene groups. Preferably, R^{C} is a branched or linear alkanediyl, cycloalkanediyl or xylenediyl radical. More preferentially, R^{C} is an alkanediyl.

Preferably, R^{C} contains 3 to 10 carbon atoms, in particular 3 to 8 carbon atoms.

Even more preferentially, R^{C} is an alkanediyl containing 3 to 10 carbon atoms. Advantageously, R^{C} is an alkanediyl containing 3 to 8 carbon atoms. Very advantageously, R^{C} is a linear alkanediyl. 1,3-propanediyl, 1,4-butanediyl, 1,5-pentanediyl, 1,6-hexanediyl, 1,7-heptanediyl and 1,8-octanediyl are most particularly suitable as groups R^{C.}

The compounds of formula (III) are well known as Grignard reagents. However, they are not known to be used as co-catalysts in a catalytic system for use in the preparation of triblock polymers. Grignard reagents of formula (III) are described, for example, in the book “Advanced Organic Chemistry” by J. March, 4th Edition, 1992, pages 622-623 or in the book “Handbook of Grignard Reagents”, Edition Gary S. Silverman, Philip E. Rakita, 1996, pages 502-503. They may be synthesized by placing magnesium metal in contact with a dihalogen compound of formula X—R^{C}—X, R^{C} being as defined according to the invention. For their synthesis, reference may be made, for example, to the collection of volumes of “Organic Synthesis”.

Like any organomagnesium compound, the organomagnesium compound of formula (III) may be in the form of a monomer species (X—Mg—R^{C}—Mg-X)₁ or in the form of a polymer species (X—Mg—R^{c}—Mg—X)ₚ, p being an integer greater than 1, notably a dimer (X—Mg—R^{C}—Mg—X)₂. Moreover, whether it is in the form of a monomer or polymer species, it may also be in the form of a species coordinated to one or more molecules of a solvent, preferably of an ether such as diethyl ether, tetrahydrofuran or methyltetrahydrofuran.

The catalytic system can be prepared conventionally by a process analogous to that described in patent application WO 2007054224 or WO 2007054223. For example, the organomagnesium reagent and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent such as methylcyclohexane, or an aromatic hydrocarbon-based solvent such as toluene.

The metallocene used for preparing the catalytic system can be in the form of a crystalline or non-crystalline powder, or else in the form of single crystals. The metallocene may be in a monomer or dimer form, these forms depending on the method of preparation of the metallocene, as is described, for example, in patent application WO 2007/054224 or WO 2007/054223. The metallocene may be prepared conventionally by a process analogous to that described in patent application WO 2007/054224 or WO 2007/054223, notably by reaction, under inert and anhydrous conditions, of the salt of an alkali metal of the ligand with a rare-earth metal borohydride, in this case of neodymium, in a suitable solvent, such as an ether, for instance diethyl ether or tetrahydrofuran, or any other solvent known to those skilled in the art. After reaction, the metallocene is separated from the reaction by-products via techniques known to those skilled in the art, such as filtration or precipitation from a second solvent. The metallocene is finally dried and isolated in solid form.

Like any synthesis performed in the presence of an organometallic compound, the synthesis of the metallocene and that of the catalytic system take place under anhydrous conditions under an inert atmosphere. Typically, the reactions are performed starting with anhydrous solvents and compounds under anhydrous nitrogen or argon.

The catalytic system is generally introduced into the reactor containing the polymerization solvent and the monomers. To achieve the desired macrostructure of the triblock polymer, a person skilled in the art adapts the polymerization conditions, notably the mole ratio of the organomagnesium reagent to the metal Nd constituting the metallocene. The amounts of co-catalyst and of metallocene reacted are such that the ratio between the number of moles of Mg of the co-catalyst and the number of moles of rare-earth metal of the metallocene is preferably from 1 to 200 and more preferentially from 1 to less than 20. The range of values extending from 1 to less than 20 is notably more favourable for obtaining polymers of high molar masses. The catalytic system is generally prepared in an aliphatic hydrocarbon-based solvent such as methylcyclohexane, or an aromatic hydrocarbon-based solvent such as toluene. Generally, after its synthesis, the catalytic system is used as is in the process for the synthesis of the polymer in accordance with the invention.

A person skilled in the art also adapts the polymerization conditions and the concentrations of each of the reagents (constituents of the catalytic system, monomers) according to the equipment (tools, reactors) used to perform the polymerization and the various chemical reactions. As is known to a person skilled in the art, the polymerization and also the handling of the monomers, of the catalytic system and of the polymerization solvent(s) take place under anhydrous conditions and under an inert atmosphere. The polymerization solvents are typically aliphatic or aromatic hydrocarbon-based solvents.

The polymerization is preferably performed in solution, continuously or discontinuously, in a reactor which is advantageously stirred. The polymerization solvent may be an aromatic or aliphatic hydrocarbon-based solvent. Examples of polymerization solvents that may be mentioned include toluene and methylcyclohexane. Advantageously, the polymerization is performed in solution in a hydrocarbon-based solvent.

The preparation of the central block is performed by copolymerization of the mixture containing ethylene and the 1,3-diene. The polymerization temperature generally varies in the range from 30 to 160° C., preferentially from 30 to 120° C. During the preparation of the central block, the temperature of the reaction medium is advantageously kept constant during the copolymerization and the total reactor pressure is advantageously also kept constant. The preparation of the central block is completed by cutting off the monomer supply, notably by dropping the reactor pressure, preferably to about 3 bar.

The preparation of the end blocks via the subsequent polymerization of ethylene is continued by applying ethylene pressure in the reactor, the ethylene pressure being kept constant until the desired consumption of ethylene to achieve the desired number-average molar mass of the end block. The ethylene polymerization temperature applied is preferably the same temperature as for the preparation of the central block. The polymerization temperature for the preparation of the end blocks generally varies in the range from 30 to 160° C., preferentially from 30 to 120° C. The pressure for the preparation of the end blocks generally varies in a range from 1 bar to 150 bar and preferentially from 1 bar to 10 bar. The synthesis of the end blocks is completed when the end blocks reach the desired number-average molar mass.

The polymerization can be stopped by cooling the polymerization medium or by adding an alcohol, preferentially an alcohol containing 1 to 3 carbon atoms, for example ethanol. The triblock polymer can be recovered according to conventional techniques known to those skilled in the art, for instance by precipitation, by evaporation of the solvent under reduced pressure or by steam stripping.

The triblock polymer in accordance with the invention has improved rheology compared to a statistical copolymer of the same microstructure and of the same macrostructure as the central block of the triblock polymer. The improvement in the rheology is apparent from a large increase in the viscosity of the polymer at low shear rates (typically less than 10 rad/s), while having a low impact on viscosity at high shear rates (typically greater than 50 rad/s). The improvement in the rheology allows more control of the polymer flow during operations that stress the polymer at low shear rate such as hot extrusion. This result is all the more surprising since it is obtained without modifying the macrostructure of the polymer, or the thermal property which is the glass transition temperature. Indeed, the triblock remains a linear chain like the statistical copolymer of the same microstructure as the central block and it retains the glass transition temperature value of this same statistical copolymer. Preferably, the triblock polymer in accordance with the invention is an elastomer.

The triblock polymer in accordance with the invention can be used in a composition, another subject of the invention, which further comprises another component. The other component may be a filler such as a carbon black or a silica, a plasticizer such as an oil, a crosslinking agent such as sulfur or a peroxide, or an antioxidant. The other component may also be a polymer, notably an elastomer. The composition may be a rubber composition.

In summary, the invention is advantageously performed according to any one of the following embodiments 1 to 24:

Embodiment 1: Triblock polymer of formula B-A-B in which the symbol A represents a “central” block which is a statistical copolymer comprising units of a 1,3-diene and more than 50 mol % of ethylene units, and the symbols B each represent an “end” block which is polyethylene with a melting point of greater than 90° C. and a number-average molar mass of greater than or equal to 2000 g/mol and less than or equal to 10 000 g/mol, the content of the ethylene units in the central block being expressed as a molar percentage relative to the number of moles of monomer units constituting the central block.

Embodiment 2: Triblock polymer according to embodiment 1, in which the central block is a statistical copolymer of ethylene and a 1,3-diene.

Embodiment 3: Triblock polymer according to either of embodiments 1 and 2, in which the central block contains more than 60 mol % of ethylene units.

Embodiment 4: Triblock polymer according to any one of embodiments 1 to 3, in which the central block contains at least 70 mol % of ethylene units.

Embodiment 5: Triblock polymer according to any one of embodiments 1 to 4, in which the central block contains not more than 90 mol % of ethylene units.

Embodiment 6: Triblock polymer according to any one of embodiments 1 to 5, in which the central block contains not more than 85 mol % of ethylene units.

Embodiment 7: Triblock polymer according to any one of embodiments 1 to 6, in which the central block has a glass transition temperature of between −90° C. and −20° C.

Embodiment 8: Triblock polymer according to any one of embodiments 1 to 7, in which the glass transition temperature of the central block is between −60° C. and −20° C.

Embodiment 9: Triblock polymer according to any one of embodiments 1 to 8, in which the glass transition temperature of the central block is between −50° C. and −30° C.

Embodiment 10: Triblock polymer according to any one of embodiments 1 to 9, in which the central block has a number-average molar mass of greater than or equal to 3000 g/mol and less than or equal to 80 000 g/mol.

Embodiment 11: Triblock polymer according to any one of embodiments 1 to 10, in which the 1,3-diene is 1,3-butadiene, isoprene or a mixture of 1,3-dienes, one of which is 1,3-butadiene.

Embodiment 12: Triblock polymer according to any one of embodiments 1 to 11, in which the 1,3-diene is 1,3-butadiene.

Embodiment 13: Triblock polymer according to any one of embodiments 1 to 12, in which the 1,3-diene is 1,3-butadiene or a mixture of 1,3-dienes, one of which is 1,3-butadiene and the central block contains 1,2-cyclohexanediyl units or 1,4-cyclohexanediyl units.

Embodiment 14: Triblock polymer according to any one of embodiments 1 to 13, in which the 1,3-diene is 1,3-butadiene or a mixture of 1,3-dienes, one of which is 1,3-butadiene and the central block contains 1,2-cyclohexanediyl units.

Embodiment 15: Triblock polymer according to any one of embodiments 1 to 14, in which the units of the 1,3-diene in the 1,2 configuration and the units of the 1,3-diene in the 3,4 configuration represent more than 50 mol % of the units of the 1,3-diene.

Embodiment 16: Triblock polymer according to any one of embodiments 1 to 15, in which the central block contains units of the 1,3-diene of 1,4 configuration.

Embodiment 17: Triblock polymer according to any one of embodiments 1 to 16, in which the central block contains units of the 1,3-diene of trans-1,4 configuration.

Embodiment 18: Triblock polymer according to embodiment 17, in which the units of the 1,3-diene of trans-1,4 configuration represent more than 50 mol % of the units of the 1,3-diene of 1,4 configuration.

Embodiment 19: Triblock polymer according to embodiment 17 or 18, in which the units of the 1,3-diene of trans-1,4 configuration represent 100 mol % of the units of the 1,3-diene of 1,4 configuration.

Embodiment 20: Triblock polymer according to any one of embodiments 1 to 19, in which B represents a linear polyethylene.

Embodiment 21: Triblock polymer according to any one of embodiments 1 to 20, in which the melting point of the end blocks is above 90° C. and below 140° C.

Embodiment 22: Triblock polymer according to any one of embodiments 1 to 21, which polymer is an elastomer.

Embodiment 23: Composition which comprises a triblock polymer according to any one of embodiments 1 to 22 and another component.

Embodiment 24: Process for synthesizing a triblock polymer defined in any one of embodiments 1 to 22, which comprises the statistical copolymerization of a monomer mixture containing ethylene and a 1,3-diene, followed by the subsequent polymerization of ethylene in the presence of a catalytic system based on at least one metallocene of formula (I) and an organomagnesium reagent of formula (II) or (III)

P(Cp¹Cp²)Nd(BH₄)_{(1+y)}Li_{y}(THF)ₓ (I)

R^{B}—(Mg—R^{A})ₘ—Mg—R^{B} (II)

X—Mg—R^{C}—Mg—X (III)

Cp¹ and Cp², which are identical or different, being chosen from the group consisting of cyclopentadienyl groups and fluorenyl groups, the groups being substituted or unsubstituted,

P being a group bridging the two Cp¹ and Cp² groups and representing a ZR¹R² group, Z representing a silicon or carbon atom, R¹ and R², which are identical or different, each representing an alkyl group comprising from 1 to 20 carbon atoms, preferably a methyl,

y, which is an integer, being equal to or greater than 0,

x, which may or may not be an integer, being equal to or greater than 0,

R^{A} being a divalent aliphatic hydrocarbon-based chain, interrupted or not with one or more oxygen or sulfur atoms or with one or more arylene groups,

R^{B} comprising a benzene nucleus substituted with the magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl,

R^{C} being a divalent aliphatic hydrocarbon-based chain, interrupted or not with one or more oxygen or sulfur atoms or with one or more arylene groups,

X being a halogen atom,

m being a number greater than or equal to 1 and preferably equal to 1.

The abovementioned features of the present invention, and also others, will be understood more clearly on reading the following description of several implementation examples of the invention, which are given as nonlimiting illustrations.

Example:

High temperature size exclusion chromatography (HT-SEC). The high temperature size exclusion chromatography (HT-SEC) analyses were performed with a Viscotek machine (Malvern Instruments) equipped with three columns (PLgel Olexis 300 mm × 7 mm I.D. from Agilent Technologies) and three detectors (differential refractometer and viscometer, and light scattering). 200 μL of a solution of the sample at a concentration of 3 mg mL⁻¹ were eluted in 1,2,4-trichlorobenzene using a flow rate of 1 mL min⁻¹ at 150° C. The mobile phase was stabilized with 2,6-di(tert-butyl)-4-methylphenol (400 mg L⁻¹). OmniSEC software was used for data acquisition and analysis. The number-average molar mass (Mn) and mass-average molar mass (Mw) of the synthesized ethylene-butadiene copolymers were calculated using a universal calibration curve calibrated from standard polystyrenes (peak molar mass Mp: 672 to 12 000 000 g mol⁻¹) from Polymer Standard Service (Mainz) using refractometric and viscometric detectors. The dispersity Ð(Ð= Mw/Mn) is also calculated.

Nuclear magnetic resonance (NMR). High resolution ¹H NMR spectroscopy of the copolymers was performed on a Brüker 400 Avance III spectrometer operating at 400 MHz equipped with a 5 mm BBFO probe. The acquisitions were made at 363 K. A mixture of tetrachloroethylene (TCE) and deuterated benzene (C₆D₆) (2/1 v/v) was used as solvent. The samples were analysed at a concentration of 17 g L⁻¹. The chemical shifts are given in ppm, relative to the deuterated benzene proton signal set at 7.16 ppm. The number of acquisitions is set at 512.

Differential scanning calorimetry (DSC) The analyses are performed on a DSC 3⁺ machine (Mettler Toledo) using a dynamic method including nine temperature stages: Stage 1: 20 to 180° C. (10° C. min⁻¹), Stage 2: isothermal 180° C. (5 min), Stage 3: 180 to −80° C. (−10° C. min⁻¹), Stage 4: isothermal −80° C. (5 min), Stage 5: −80 to 180° C. (10° C. min⁻¹), Stage 6: isothermal 180° C. (5 min), Stage 7: 180 to −80° C. (10° C. min⁻¹), Stage 8: isothermal −80° C. (5 min), Stage 9: −80 to 180° C. (10° C. min⁻¹). The first two rises allow the thermal history of the sample to be erased. The glass transition temperature and melting point are measured on the ninth stage. The seventh stage is also retained to obtain information regarding the crystallization of the sample.

Rheological analysis The analyses are performed on a MARS 60 rotational rheometer (Thermo Scientific) equipped with a lower plate/Peltier upper oven assembly with 8 mm plate-plate geometries. The powder samples are pressed in the form of discs at 150° C. (thickness 1 to 1.5 mm) for 5 min, then cut with a hollow punch in the form of discs with a diameter of 8 mm. They are inserted in the rheometer at 150° C.

Example 1: Preparation of a Co-Catalyst, 1,5-Di(Magnesium Bromide)Pentanediyl (DMBP):

1.25 g (50 mmol, 10 equivalents) of magnesium are inertized in a 50 mL flask fitted with a magnetized olive and mounted with a 10 mL dropping funnel. A diiodine bead (10 mg) is added to the magnesium. 11 mL of MeTHF distilled over sodium/benzophenone are placed in the flask with stirring and 9 mL are placed in the dropping funnel. 0.68 mL of 1,5-dibromopentane (5 mmol, 1 equivalent) degassed and dried over activated molecular sieves is placed in the dropping funnel. The haloalkane solution is poured dropwise onto the magnesium over 1 h. Stirring is continued for 12 h at 20° C. This solution is concentrated under vacuum and then diluted in 10 mL of toluene. The concentration of pentanediyl group is estimated at 0.45 mol L^{-1.}

¹H NMR (C₆D₆-400 MHz-298 K)δ: ppm = 2.06 (quint, J = 7.6 Hz, “b”), 1.80 (quint, J = 7.4 Hz, “c”), −0.05 (t, J = 7.7 Hz, “a”); quint for quintet.

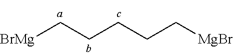

Example 2: Preparation of a Reference Statistical Copolymer of Ethylene and 1,3-Butadiene

200 mL of toluene (Biosolve) purified on an SPS800 MBraun system are placed in an inertized 250 mL flask equipped with a magnetized olive. 0.31 mL (0.14 mmol) of a solution of 1,5-di(magnesium bromide)pentanediyl (DMBP 0.45 mol L⁻¹) prepared according to Example 1 is added to the flask with stirring. 32 mg (50 μmol of neodymium) of {(Me₂Si(C₁₃H₈)₂)Nd(—BH4)[(—BH₄)Li(THF)]}₂ are then added to the flask.

The catalytic solution is transferred through a cannula into a 250 mL reactor under an inert atmosphere at 70° C. The argon excess pressure in the reactor is reduced to 0.5 bar and the reactor is then pressurized to 4 bar with an ethylene/butadiene mixture with a mole ratio of with stirring at 1000 rpm. The pressure is kept constant in the reactor by means of a tank containing the ethylene/butadiene mixture. After a drop in pressure in the tank equivalent to about 10 g of monomers for a desired Mn of 72 000 g mol⁻¹, the feed is stopped, the reactor is degassed and the temperature is reduced to 20° C. The copolymer solution is precipitated from methanol with stirring in the presence of about 20 mg of 2,2′-methylenebis(6-tert-butyl-4-methylphenol) as antioxidant. The copolymer obtained is dried under vacuum at 70° C. for 4 hours.

Example 3: Preparation of a Triblock Polymer in Accordance with the Invention, with a Statistical Copolymer Central Block of Ethylene and 1,3-Butadiene and Polyethylene End Blocks:

200 mL of toluene (Biosolve) purified on an SPS800 MBraun system are placed in an inertized 250 mL flask equipped with a magnetized olive. 0.6 mL (0.25 mmol) of a solution of 1,5-di(magnesium bromide)pentanediyl (DMBP 0.45 mol L⁻¹) prepared according to Example 1 is added to the flask with stirring. 16 mg (25 μmol of neodymium) of {(Me₂Si(C₁₃H₈)₂)Nd(—BH₄)[(—BH₄)Li(THF)]}₂ are then added to the flask.

Preparation of the central block (Step 1): The catalytic solution is transferred through a cannula into a 250 mL reactor under an inert atmosphere at 70° C. The argon excess pressure in the reactor is reduced to 0.5 bar and the reactor is then pressurized to 4 bar with an ethylene/butadiene mixture with a mole ratio of 80/20 with stirring at 1000 rpm. The pressure is kept constant in the reactor by means of a tank containing the ethylene/butadiene mixture. After a pressure drop in the tank equivalent to about 13 g of monomers, the feed is stopped and the reactor is isolated until the pressure in the reactor reaches 2.8 bar to yield 15 g of copolymer, i.e. a desired Mn for the central block of 60 000 g.mol^{-1.}

Preparation of the end blocks (Step 2): The reactor is again pressurized to 4 bar using a tank containing ethylene only, then about 3 g of monomers are consumed by pressure drop in the tank, i.e. a desired Mn for the end blocks of 6000 g.mol⁻¹ each.

The reactor is degassed and the temperature is reduced to 20° C. The copolymer solution is precipitated from methanol with stirring in the presence of about 20 mg of 2,2′-methylenebis (6-tert-butyl-4-methylphenol) as antioxidant. The copolymer obtained is dried under vacuum at 70° C. for 4 hours.

The characteristics of the polymers appear in Table 1. In Table 1, the ethylene unit content, the content of 1,3-butadiene units in the 1,2-configuration (1,2-unit), in the 1,4-configuration (1,4-unit) and the 1,2-cyclohexanediyl unit (ring unit) content are expressed as molar percentages relative to the total monomer units of the polymer. The rheological properties appear in Table 2.

TABLE 1

| | Ethylene | 1,2 | 1,4 | Ring | Tg | Tf | Degree (%) | Mₙ | |
|---|---|---|---|---|---|---|---|---|---|
| Ex. | unit | unit | unit | unit | (C) | (C) | crystallinity | (g/mol) | Ð |
| 2 | 74.4 | 10.0 | 5.9 | 9.7 | −35 | — | — | 61400 | 1.9 |
| 3 | 81.9 | 6.7 | 4.0 | 7.4 | −35 | 122 | 8.9 | 62600 | 2.9 |

TABLE 2

| | G′ at | G′ at |
|---|---|---|
| | 0.1 Hz at | 10 Hz at |
| Ex. | 150° C. | 150° C. |
| 2 | 100 | 100 |
| 3 | 285 | 115 |

The comparison of Examples 2 and 3 show that the G′ value of the triblock measured at low shear rates, typically less than 10 rad/s, is increased relative to the reference polymer. Indeed, at 0.1 Hz (i.e. 0.6 rad/s) it is almost 3 times greater than that of the G′ of the reference polymer. For high shear rates, typically greater than 50 rad/s, the multiplication factor is much less, since it is only 1.1 at 10 Hz (i.e. 62 rad/s).

The use of a triblock polymer according to the invention as a replacement for a statistical polymer indeed allows a large increase in the viscosity of the polymer at low shear rates, while the impact on the viscosity is relatively low at high shear rates. This increase in viscosity at low shear rates makes it possible to limit the flow phenomena of the polymer in the processes for converting the polymer at low shear rates without significant modification of its rheological properties at high shear rates. These results reflect an improvement in the rheology of a statistical copolymer of ethylene and a 1,3-diene without changing the macrostructure of the triblock relative to the statistical copolymer and the microstructure of the statistical copolymer part, thus making it possible to retain also the intrinsic properties of the statistical copolymer in the triblock polymer.

1. A triblock polymer of formula B-A-B in which the symbol A represents a “central” block which is a statistical copolymer comprising units of a 1,3-diene and more than 50 mol % of ethylene units, and the symbols B each represent an “end” block which is a polyethylene with a melting point of greater than 90° C. and a number-average molar mass of greater than or equal to 2000 g/mol and less than or equal to 10 000 g/mol, the content of the ethylene units in the central block being expressed as a molar percentage relative to the number of moles of monomer units constituting the central block.

2. The triblock polymer according to claim 1, in which the central block is a statistical copolymer of ethylene and 1,3-diene.

3. The triblock polymer according to claim 1, in which the central block contains more than 60 mol % of ethylene units.

4. The triblock polymer according to any one of claim 1, in which the central block contains not more than 90 mol % of ethylene units.

5. The triblock polymer according to any one of claim 1, in which the central block contains not more than 85 mol % of ethylene units.

6. The triblock polymer according to any one of claim 1, in which the central block has a glass transition temperature of between −90° C. and −20° C.

7. The triblock polymer according to claim 1, in which the central block has a number-average molar mass of greater than or equal to 3000 g/mol and less than or equal to 80 000 g/mol.

8. The triblock polymer according to claim 1, in which the 1,3-diene is 1,3-butadiene, isoprene or a mixture of 1,3-dienes, one of which is 1,3-butadiene.

9. The triblock polymer according to claim 1, in which the 1,3-diene is 1,3-butadiene or a mixture of 1,3-dienes, one of which is 1,3-butadiene and the central block contains 1,2-cyclohexanediyl units or 1,4-cyclohexanediyl units.

10. The triblock polymer according to claim 1, in which the polymer is an elastomer.

11. A composition which comprises a triblock polymer according to claim 1 and another component.

12. A process for synthesizing a triblock polymer defined in claim 1, which comprises the statistical copolymerization of a monomer mixture containing ethylene and a 1,3-diene, followed by the subsequent polymerization of ethylene in the presence of a catalytic system based on at least one metallocene of formula (I) and an organomagnesium reagent of formula (II) or (III)
P(Cp¹Cp²)Nd(BH₄)_{(1+y)}Li_{y}(THF)ₓ (I)
R^{B}—(Mg—R^{A})ₘ—Mg—R^{B} (II)
X—Mg—R^{C}—Mg—X (III)
Cp¹ and Cp², which are identical or different, being chosen from the group consisting of cyclopentadienyl groups and fluorenyl groups, the groups being substituted or unsubstituted,
P being a group bridging the two Cp¹ and Cp² groups and representing a ZR¹R² group, Z representing a silicon or carbon atom, R¹ and R², which are identical or different, each representing an alkyl group comprising from 1 to 20 carbon atoms,
y, which is an integer, being equal to or greater than 0,
x, which may or may not be an integer, being equal to or greater than 0,
R^{A} being a divalent aliphatic hydrocarbon-based chain, interrupted or not with one or more oxygen or sulfur atoms or with one or more arylene groups,
R^{B} comprising a benzene nucleus substituted with the magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl,
R^{C} being a divalent aliphatic hydrocarbon-based chain, interrupted or not with one or more oxygen or sulfur atoms or with one or more arylene groups,
X being a halogen atom,
m being a number greater than or equal to 1.

13. The triblock polymer according to claim 3, in which the central block contains more than 70 mol % of ethylene units.

14. The triblock polymer according to claim 8, in which the 1,3-diene includes 1,3-butadiene.

15. The triblock polymer according to claim 9, in which the central block contains 1,2-cyclohexanediyl units.

16. The process according to claim 12, in which R¹ and R² each represent a methyl.

17. The process according to claim 12, in which m is equal to 1.
